(19) United States
(12) Patent Application Publication
(10) Pub. No.: US 2011/0320201 A1
(43) Pub. Date: Dec. 29, 2011

(54) SOUND VERIFICATION SYSTEM USING TEMPLATES

(76) Inventor: John D. KAUFMAN, San Francisco, CA (US)

(21) Appl. No.: 13/152,149

(22) Filed: Jun. 2, 2011

Related U.S. Application Data
(60) Provisional application No. 61/398,312, filed on Jun. 24, 2010.
(60) Provisional application No. 61/398,313, filed on Jun. 24, 2010.
(60) Provisional application No. 61/398,314, filed on Jun. 24, 2010.

(51) Int. Cl. G10L 15/04; G10L 15/00

(52) U.S. Cl. 704/251; 704/231; 704/E15.001; 704/E15.005

(57) ABSTRACT

An audio signal verification system is presented for verifying the sound is from a predetermined source. Various methods for analyzing the sound are presented and the various methods may be combined to vary degrees to determine an appropriate correlation with a predefined pattern. Moreover a confidence level or other indication may be used to indicate the determination was successful. The sound may be reduced to templates with varying degrees of richness. Also different templates may be created using the same sound source and different sounds from the same source may be aggregated to form a single template. Comparisons may be made comparing a sound or a template derived from that sound with stored sounds or templates derived from that stored sound. Moreover comparisons can be made using templates of different richness to achieve confidence levels and confidence levels may be represented based on the results of the comparisons.

### PRIORITY

This application claims the benefit of the following Provisional Patent Applications, each of which are included herein as if fully set forth.
Application 61/398,312 entitled “Method for Providing Multiple Templates of the Same Individual Speaker in a Speaker Verification System” filed Jun. 24, 2010 by the same inventor (John D. Kaufman).
Application 61/398,313 entitled “Archival Ability Within a Speaker Verification System” filed Jun. 24, 2010 by the same inventor (John D. Kaufman).
Application 61/398,314 entitled “Method of Voice Template Storage for Added Security” filed Jun. 24, 2010 by the same inventor (John D. Kaufman).

### BACKGROUND

Speaker recognition is correlated with physiological and behavioral characteristics of speech production that have been found to differ between different people. These acoustic patterns derive from both the spectral envelope (vocal tract characteristics) and the supra-segmental features (voice source characteristics) of a person's speech. The patterns reflect both anatomy (e.g., size and shape of the throat and mouth) and learned behavioral patterns (e.g., voice pitch, speaking style).

Speaker recognition can be broadly classified into either speaker identification or speaker verification. Speaker identification is the process of determining from which of a predetermined selection of speakers a given utterance comes. Whereas speaker verification is the process of accepting or rejecting the identity claimed by a speaker. Conventionally speaker identification looks for similarities with standard models, whereas speaker verification looks for differences with a standard model.

To this effect, a speaker recognition system would have two parts: enrollment and verification. During enrollment, the speaker's voice is recorded and typically a number of features are extracted to form a voice print. In the verification phase, a speech sample or “utterance” is compared against a previously created voice print. For identification systems, the utterance is compared against multiple voice prints in order to determine the best possible match while verification systems compare an utterance against a single voice print to ensure the identity.

Conventionally, researchers have developed a wide variety of mathematical techniques to effectuate a speaker verification system. One of the most commonly used short-term spectral measurements are cepstral coefficients (a sort of a nonlinear “spectrum-of-a-spectrum”) and their regression coefficients. As for the regression coefficients, typically, the first-and second-order coefficients, that is, derivatives of the time functions of cepstral coefficients, are extracted at every frame period to represent the spectral dynamics.

Among the various other technologies used to process and audio information (such as voice prints) include frequency estimation, which estimates the frequency components of an audio signal in the presence of noise. Noise may be ambient background noise or other unwanted signals from the audio transducer. Noise can be common-mode or frequency or device specific.

Other technologies include hidden Markov models which are especially known for their application in temporal pattern recognition such as speech recognition, and bioinformatics. In addition Gaussian mixture models, pattern matching algorithms, neural networks, matrix representation, vector quantization and decision trees have been applied to voice print analysis.

A drawback to conventional methods of speaker verification is the large amount of data and data processing required to effectuate a workable biometric system using a person's voice. Complex operations such as Fourier transforms and de-noising limit voice identification because of the need for processing power. Moreover, spectrograms require large amounts of storage. In combination, both these limitations also operate to limit voice verification on portable devices.

### BRIEF DESCRIPTION OF THE DRAWINGS

FIG. 1 shows a functional block diagram of a client server system that may be employed for some embodiments according to the current disclosure.

FIG. 2 represents an audio signal (audiogram) shown as a variation in amplitude over time and a spectrogram of that signal.

FIG. 3 shows a spectrogram of the audio signal shown in FIG. 2B.

FIG. 4 shows a spectrogram of the same audiogram as FIG. 2A.

FIG. 5 shows a method for certain embodiments of a speaker verification system.

FIG. 6 shows a method for certain embodiments according to the current disclosure.

### SUMMARY

Disclosed herein is a system and method for verifying that an audio signal (sound) is from a designated source. The audio may be generated by any source including but not limited to machines and humans. Various methods for analyzing the sound are presented and the various methods may be combined to vary degrees to determine an appropriate correlation with a predefined pattern. Moreover a confidence level or other indication may be used to indicate the determination was successful.

As disclosed herein the sound may be reduced to templates with varying degrees of richness, richer templates include more detail. In addition different templates may be created using the same sound source and different sounds from the same source may be aggregated to form a single template. Comparisons may be made comparing a sound or a template derived from that sound with stored sounds or templates derived from that stored sound. Moreover comparisons can be made using templates of different richness to achieve confidence levels and confidence levels may be represented based on the results of the comparisons.

The templates and sounds may be persisted on a wide variety of memory devices including but not limited to servers, mobile devices and portable memory devices and “smart cards.” Operations to verify the sound may be conducted on a wide variety of devices including but not limited to servers and client-server system.

Techniques are disclosed herein for creation, manipulation and operations involving templates along with their application towards sound or speaker verification. These techniques provide for faster processing and easier use as compared to operations involving raw audio data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### Lexicography

Read this application with the following terms and phrases in their most general form. The general meaning of each of these terms or phrases is illustrative, not in any way limiting.

The terms “audio signal”, “audio files” and the like generally refer to digital or analog electronic signals representing, at least in part, one or more sounds. Audio signals and files are generally created through the use of sound transducers which create electronic signals in response to sound. As used herein an audio signal may be analog or digitized.

The term Spectrogram generally refers to a graph that shows a sound's frequency on the vertical axis and time on the horizontal axis. Spectrograms may be computed and kept in computer memory as a two-dimensional array of acoustic energy values. For a given spectrogram S, the strength of a given frequency component fat a given time t in the speech signal is generally represented by the darkness or color of the corresponding point S(t,f).

The term Phonemes generally refers to categories which allow grouping subsets of speech sounds. Even though no two speech sounds, or phones, are identical, all of the phones classified into one phoneme category are similar enough so that they convey the same general meaning.

The term “wireless device” generally refers to an electronic device having communication capability using radio, optics and the like.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

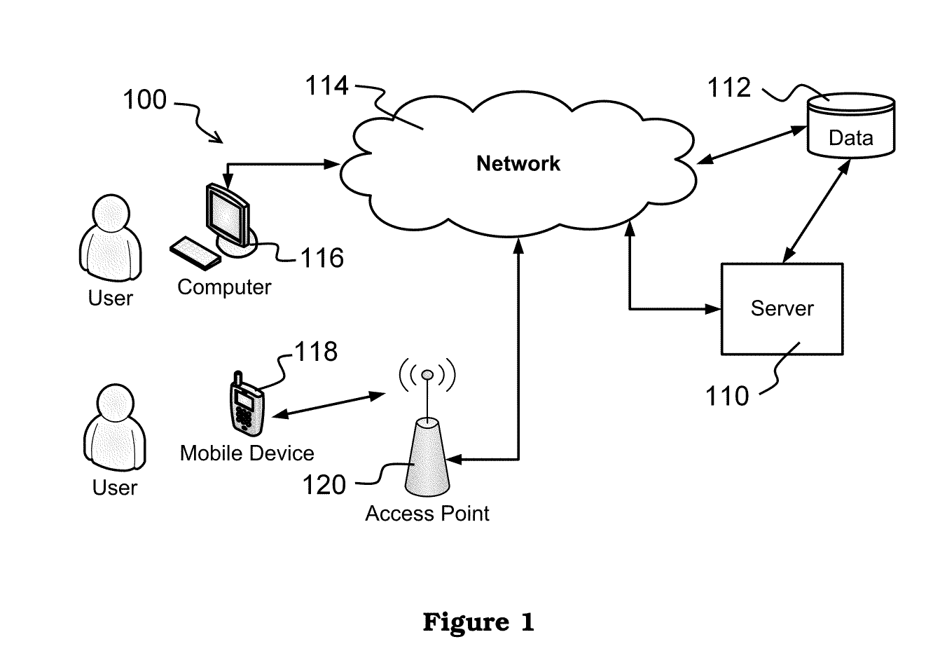

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Structured Data

Sound information may be recorded (or persisted) in several ways. The most common way is to record a sound for a period of time. This allows for presentation of the sound along a timeline. A structured data source such as a spreadsheet, XML file, database and the like may be used to record events and the time they occurred. The techniques and methods described herein may be effectuated using a variety of hardware and other techniques that persist data and any of the ones specifically described herein are by way of example only and are not limiting in any way. In particular, as disclosed herein, audio signals and templates representing audio characteristics of a signal source may be stored as structured data. Moreover those audio signals and templates may be stored as encrypted data and accessed using conventional secure communications methodologies. In addition separate sound recordings can be combined and saved then modified over time. For example, the persisted data can be update by altering a portion of the recording by replacing a voice portion of a recording with an updated voice recording.

### Templates

As presented herein different techniques are described to create templates for the storage and analysis of noise signals. These signals may be animal based such as human voice signals or other machine-based signals. The techniques presented herein may be used alone or in combination with other techniques to effectuate a desired result.

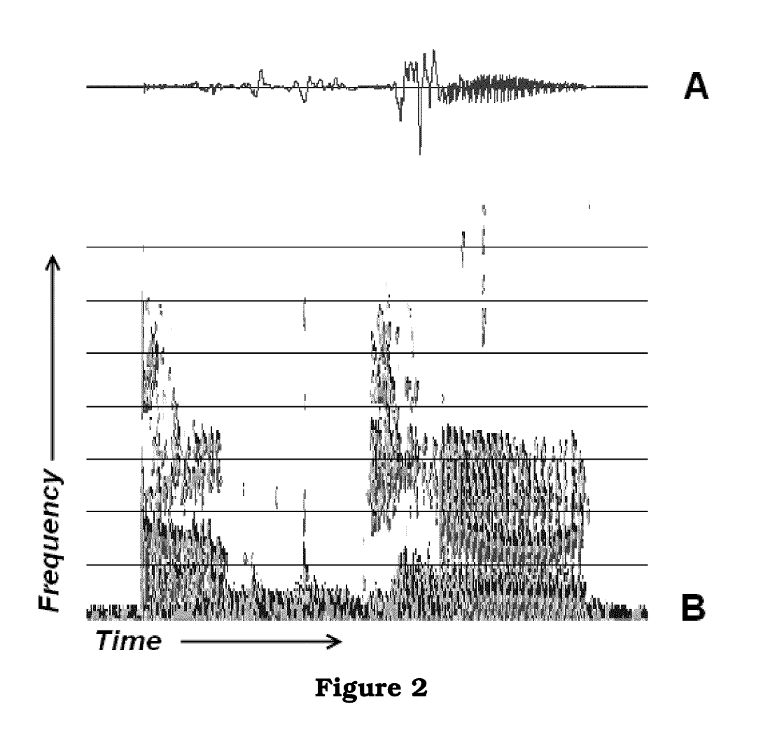

FIG. 2A represents an audio signal (audiogram) shown as a variation in amplitude over time. The signal may represent a word, a collection of phones, a collection of phonemes or any other recordable audio signal. FIG. 2A represents an audio signal as it would normally be recorded by microphone. FIG. 2B is a spectrogram of the same signal shown in FIG. 2A. The spectrogram is created by taking Fourier transforms of the signal in FIG. 2A and representing them to show the different frequencies that constitute the signal represented in FIG. 2A. To create FIG. 2B from the signal in FIG. 2A a processor must do extensive Fourier transform analysis. The resulting data is fairly complex data form and requires extensive storage capacity to adequately represent the spectrogram in memory. Moreover, if a comparison need be made between multiple spectrograms even more processing is required.

The signal in FIG. 2A can be simplified several different ways. A simple way may be to count how many times the signal crosses the zero intensity mark. Zero-crossing detectors are fairly well known in the art and have the effect of simplifying an audiogram into a single number. Moreover, a linear array of numbers indicating the time sequences of zero crossing or a signal may be a basis for a template. Even though these simplifications will generally not provide enough information, they can form the basis for a template to compare words, phones or phonemes. A more robust (richer) template can be made by determining the number of zero-crossing in a given period of time. If the speaker speaks the same word several times, the number of zero-crossings can be averaged for a given time and the average can form a template. This average will represent not only the magnitude of the audiogram but also provide a frequency component because higher frequency signals will cross zero more often than lower frequency signals. One having skill in the art would recognize that a predetermined start and stop time may be needed or a fixed time may be used starting from the maximum amplitude of the audiogram or, if need be from other predefined thresholds. Moreover, a longer audio signal provides for a more robust and richer a template.

Similarly a predetermined level could be used instead of zero, in effect creating a threshold-crossing detector. This would have the affect of only counting peaks (or minima) but achieve a similar result. Accordingly the audiogram can be represented as a single number or an array of numbers. Using less data to represent an audiogram provides for much more efficient storage and transmission.

Common-mode rejection may be employed to subtract low amplitude “quiet” noise signals from signals portions containing information. This has the effect of providing a cleaner more portable template. Moreover, different templates may be formed using multiple transducers having the effect of providing standardized templates for a given speaker or noise source.

Other ways to simplify the audiogram may include calculating a ratio between the signal maximum and the average signal or ratio between one or more maximums. In addition, first and second derivative analysis can provide numeric indicators about the shape of the overall waveform in the audiogram. Zero-crossing detection of derivative signals may provide for templates based on irregularly shaped audiograms. These techniques allow for the audiogram to be represented as either a single number or short sequence of numbers wherein the sequence represents the signal but without as complete detail as in signal itself.

The envelope of a waveform may be quantified and used a as template. This has the effect of providing a simplified mathematical formulaic signal to describe a noise such as a word of phone or phoneme. Curve fitting may be used to represent sequences of numbers generated. For example and without limitation, a best fit curve or straight line may be use to represent an array of numbers where each number is a zero-crossing time interval of a first derivative graph of an audiogram.

Other techniques for audio analysis may be employed for certain embodiments. For example and without limitation:
Speaker Verification Using Adapted Gaussian Mixture Models by Reynolds, et al. Digital Signal Processing 10, 19-41 (2000).
Robust Text-independent Speak Identification Using Gaussian Mixture Speaker Models, Reynolds, et al. IEEE Transactions on Speech and Audio Processing Vol. 3, No. 1.
Robust Speaker Recognition in Noisy Conditions, Ming, Ji et al. IEEE Transactions on Speech and Audio Processing Vol. 15, No. 5. (2007).
Each of these references is filed in the appendix and is fully incorporated into the specification as if fully set forth herein.

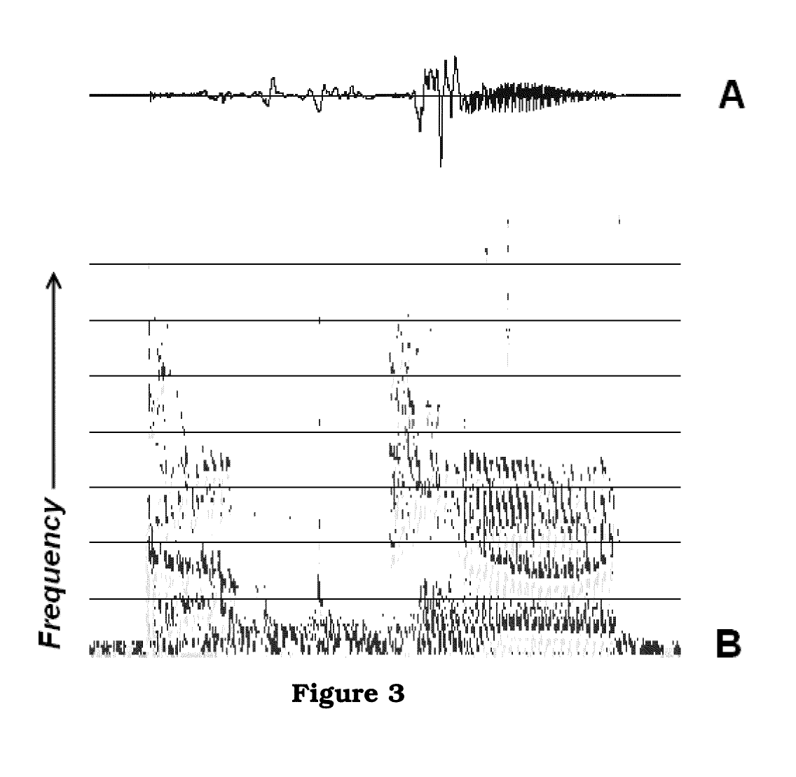

FIG. 3B is a spectrogram of the audio signal shown in FIG. 2B. In FIG. 3B the lowest intensity signals (those below a certain threshold) have been removed. Accordingly FIG. 3B represents a data-reduced template of the spectrogram of FIG. 2B which consequently requires less storage and less processing to manipulate. Moreover, having less data, the spectrogram of FIG. 3B is easier to compare to other spectrograms. Those having skill in the art will recognize that the representation of FIG. 3B could be effectuated using non-linear techniques to remove low or high intensity frequency data to create a template similar to that shown in FIG. 3B. The information of FIG. 2B is “richer” in the sense that is contains more detailed information. Similarly templates may be “richer” or “poorer” in relation to each other even when based upon the same underlying audio signal.

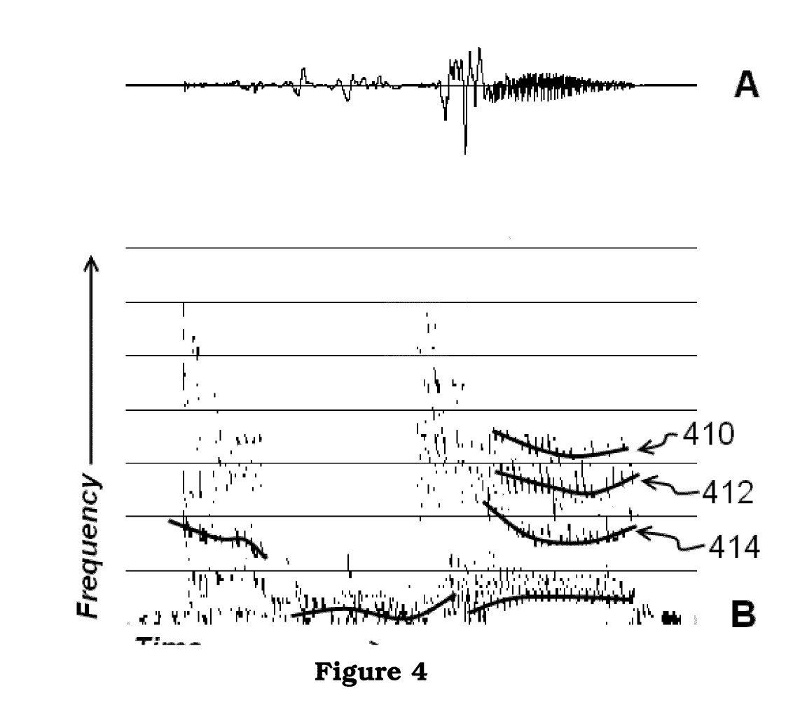

FIG. 4B shows a spectrogram of the same audiogram as FIG. 2A. In FIG. 4B only the most intense frequency information is presented on the graph. By further removing low intensity frequency information from the spectrogram the data becomes more manageable, in particular with regard to comparing spectrogram information since there is less data to compare. The frequency information also includes areas of intense frequency components 410, 412 and 414 among others. These intense frequency component areas may be delineated and grouped and represent characteristics of the source of the audible signal. For example and without limitation, an audio source may have multiple areas such as a bass or alto region that particularly characterize that voice. Regions such as 410, 412 and 414 and others provide a template for the sound of FIG. 4A.

The regions represented by 410, 412 and 414 may be characterized by a best fit line using techniques described herein or other standard curve fitting techniques or shape characterizing techniques. Accordingly the lines 410, 412 and 414 may be stored as templates without the need to store any raw data from the spectrogram. Moreover relationships between lines further characterize the sound and either stand-alone or together may also be stored as part of template information.

Templates may be derived from the same sound source using multiple transducers. For example and without limitation, a speaker may create a template for accessing a building using a microphone at a door. In addition the speaker may create a template for accessing secure information on a computer server using a microphone attached to the computer. Software may be employed to determine correlations between the two sound sources and create a combined template or a relationship between the templates. Thus associated, a system may be created to try multiple templates to determine a confidence interval before providing access. This confidence interval could be based upon conventional statistical techniques or another predetermine factor. In the present example a system could first try templates for door access and if a required confidence is not obtained, compare templates for computer access to see if sufficient confidence may be obtained.

Templates may be defined covering a range of state variation from the source of the sound. For example and without limitation templates may be derived from the same sound source but at different times of the day or in different states such as illness, excitedness, weariness and the like. Alternatively templates may be derived from the same sound source but at different times of the year or over a several year period. This has the effect of providing a template family. A template family may be used to characterize a speaker during different states, say for example under stress or suffering from an illness. Additionally, a speaker may not have to utter actual words, but templates made from non-intelligible utterances may be employed or even foreign language words or phrases may be used.

Templates can be made from the same speaker, but having the speaker speak in different languages. For example and without limitation a speaker may say a word in English, then say the Spanish equivalent. Multiple templates such as English only, Chinese only or in combination may be stored and used.

One having skill in the art will recognize that templates may be stored and/or transmitted along with payload information such as user information, location information and time information.
Machine-Based Sound

The techniques described above are not limited to human or animal sounds. Machine-based audio signals may be characterized as templates. Moreover, machines having systematic noise or repetitive sound may be characterized using a small array indicating the primary harmonics. In addition machine-based sound or noise may be used to add to or subtract from the raw audio signal. For example and without limitation sound may include a human voice coupled with “background noise” which might be machine based noise. The background noise signal might be used to indication a location or likely location of the speaker. Templates may be formed for both the speaker and the background in essence de-convoluting the sound and creating individual templates. The templates may then be recombined in different complexities and combinations to create successively richer templates.

Background noise might be de-convoluted from the signal and treated separately. For example and without limitation a spectrogram contains background noise or systemic noise generated by an audio transducer. The noise should be different for each transducer used or for each location where the audio was captured. Background or systemic noise will often fall outside the audio spectrum and be identifiable on the spectrogram. Moreover certain sources of noise such as car engines may be identifiers and increase the robustness of a system. Templating background noise or transducer noise provides for secondary means of identify the source of a sound because the transducer or location may be identifiable. For example and without limitation a template derived from an automobile may be stored and used in conjunction with a person speaking on a cell phone in that automobile. Combining templates from the speaker, the automobile and system noise from the cell phone provides increased robustness and operates to effect a likelihood that the speaker is a specific location and using a specific device.

### Dynamic Template Creation

In certain embodiments templates may be created dynamically. For example and without limitation, raw data may be persisted in a memory. When the data is needed a template is derived and transmitted to the requester. This has the effect of moving processing to a storage/server device and reducing the necessary transmission bandwidth. Moreover a template could be created at a first device such as a smart phone and only the template transmitted to a second device. The second device could dynamically create a template from its stored data and compare the templates to determine a match or other correlation. Similarly a remote device can be preloaded with authorized templates from a server or other storage/processing device. The smart device then only needs to create a template and check local memory to verify a speaker.

### Operations

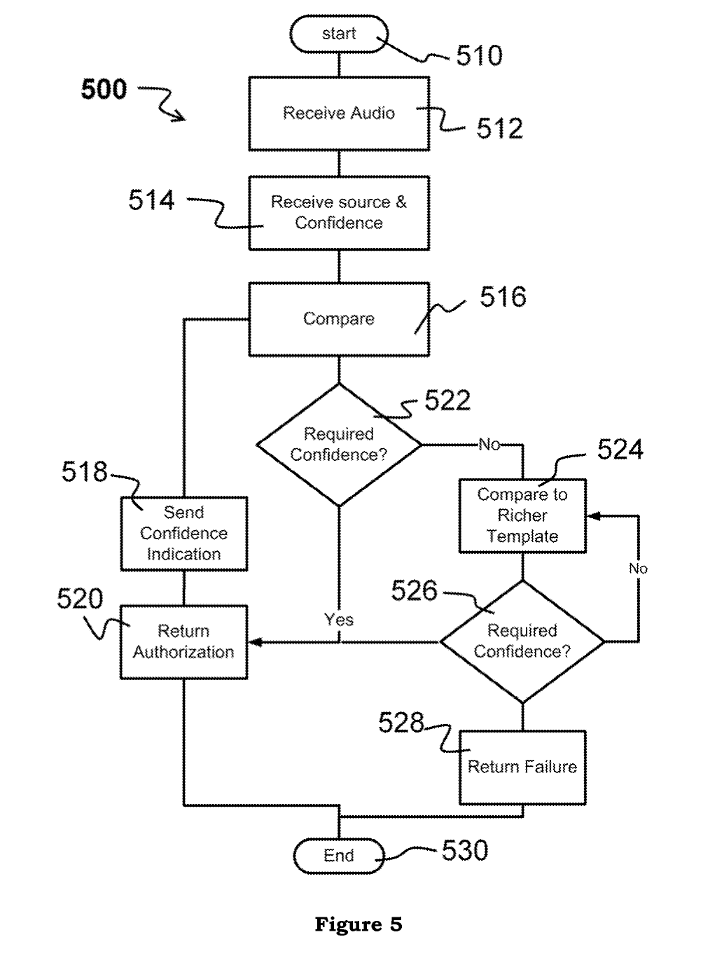

FIG. 5 shows a method 500 for certain embodiments of a speaker verification system. In certain embodiments the method 500 may be executed by an execution engine. At a flow label 510 the method 500 begins.

At a step 512 a system receives an audio signal or structured data representing an audio signal.

At a step 514 the system may receive a source identifier and a confidence requirement. The confidence requirement may be specific or a variation on a default and may include a parameter indicating the richness of template comparison. In certain embodiments the confidence requirement may be optional. This allows for a confidence indicator that is associated with a certain template richness.

The source identifier may include the name or other identification of the audio signal. For example and without limitation, the source identifier might be a person's name, phone number or an employee identification number. The source identifier may also include location, date, time and/or other associated information about the source. This may include for example, type of source input such as microphone, telephone, recording and the like. Cookies or other local storage procedures may be used to record the source identifier information.

At a step 516 a comparison is performed. This comparison includes creating one or more templates from the received audio of step 512 and comparing that template to those persisted in memory. This comparison may involve one or more of the techniques defined herein. The techniques may include (without limitation) curve fitting, least-squares analysis and other forms of statistical operations. Moreover, this comparison may operate with complex templates or combinations of templates. Optional parameters may be used to specify the type of comparison and the type of templating to be performed. Also parameters may be used to direct the process. In the example shown a parameter may indicate that only a minimum confidence level is required, or that an authorization be returned regardless of the confidence indication.

At a step 518 the results of the comparison are returned. It is noted that this step is performed if the confidence does not have to meet any minimum requirements. This result indication a degree of certainty the received audio is actually from the source identifier of step 514, but that certainty can be any value.

At a step 522 the confidence is compared to the required confidence. If the confidence level meets or exceeds the required level operation proceeds to a step 520 otherwise the process proceeds to a step 524.

At a step 520 an authorization is returned (if required). The return authorization would generally indicate that the source compared at or above the required confidence in relation to the template persisted in memory. Operation then proceeds to a flow label 530 indicating the end of the method.

A step 524 is reached if the received audio did not meet the required confidence level. At the step 524 a comparison is using richer templates. For example and without limitation the richer templates could be developed from the received audio, or from persisted memory or in combination of the two. Use of a simpler template initially allows for faster processing with less demand on resources such as bandwidth and memory. Also simpler templates require less user and administrator time. Increasing the richness of the templates requires more resources, but may provide a better match for situations where there is uncertainty about the quality of the received audio or the received audio is of poor quality.

At a step 526 the confidence is again compared to the required confidence. If the required confidence is met, flow continues to the step 520 described above. If not flow continues to either the step 524 or the step 528 depending on the source and confidence information provided in the step 514. If that information requires multiple iterations of increasing richer (or less rich as the case may be) templates, processing may continue through the steps 524 and 526 until the required iterations are met. When the required iterations are met flow continues to a step 528.

At a step 528 a failure indication is returned and flow proceeds to a flow label 530 where the method ends.

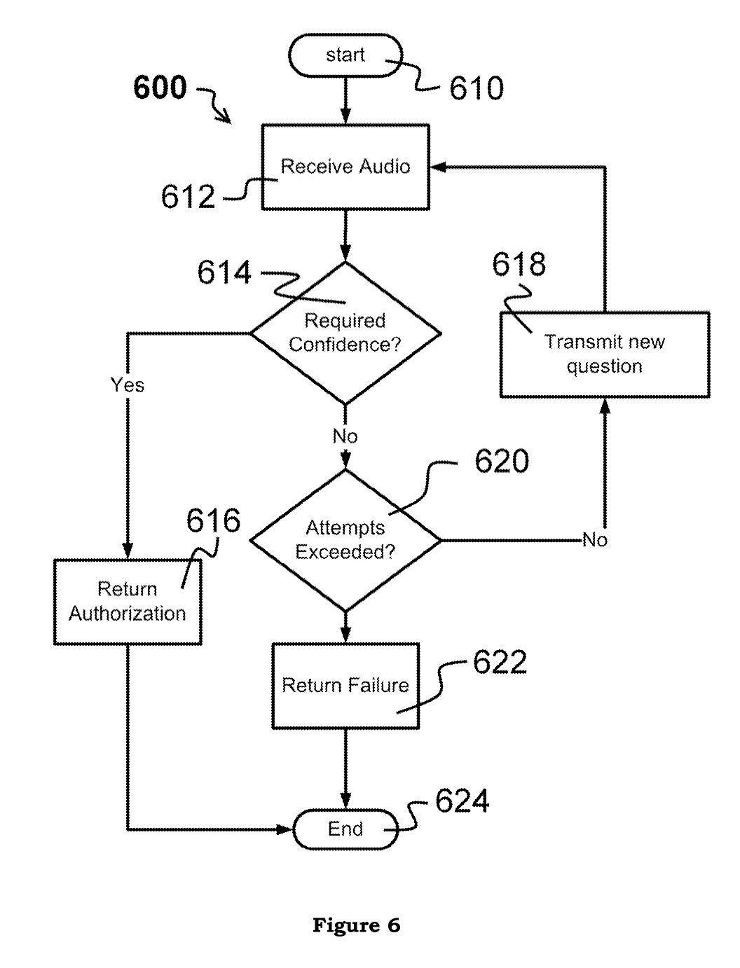

FIG. 6 shows a method 600 for certain embodiments according to the current disclosure. In certain embodiments the method 600 may be implemented using an execution engine. The method begins at a flow label 610 and proceeds to a step 612.

At a step 612 a system receives an audio signal or data representing an audio signal. The audio signal may be in response to a previously established question to a user. The system may also receive one or more parameters directing the flow of the process and providing support information for the process such as an attempt parameter.

At a step 614 the audio is analyzed to see if it meets a certain predefined confidence. This comparison includes creating one or more templates from the received audio and comparing that template to those persisted in memory. This comparison may involve one or more of the techniques defined herein. Moreover, this comparison may operate with complex templates or combinations of templates. If the required confidence is met the flow proceeds to a step 616, else flow proceeds to a step 620.

At a step 616 an authorization signal is returned and flow proceeds to a flow label 624 ending the method.

At a flow label 620 the number of attempts to authorize is incremented and the value is compared to a setting for the maximum amount of attempts. If the number of attempts is exceeded then flow proceeds to a flow label 622, else flow proceeds to a flow label 618.

At a flow label 622 a failure indication is returned by the method and flow proceeds to a flow label 624 indicating the end of the method.

At a step 618 a new question is generated and presented to a user. This question is based on stored audio or templates. The question may be from a data source associating the question with an audible response. A template based on that audio response may be used to compare additional received audio by proceeding to the step 612 and iterating through the method. The iterations may continue with each iteration asking a different question and receiving a different audio response until the required confidence is met or the number of attempts is exceeded. One having skill in the art will note that besides changing the question in the step 618, each new audio received could be compared to a richer (or less rich) template as described herein. Moreover varying the type and nature of the questions increases confidence there is a live user operating the system.

The method may be augmented using a speech recognition system. For example and without limitation the speech recognition system may recognize the words being spoken to determine whether or not they answer the question asked in step 61 above. This increase security because the person speaking must be able to understand the question and answer it intelligibly.

The verification process may be augmented by providing for individualize thresholds of acceptable correlations. For example and without limitation a user may individually select and modify a particular speaker's acceptable verification threshold in circumstances where the verification process for that speaker's voice consistently fails to reach an acceptable verification rate. This allows for a system wherein each user has a predetermined minimally acceptable correlation between a voice sample and a previously stored template from that speaker.

Portable Devices

Templates may be stored on any device capable of persisting data. This may include “smart cards” which are portable devices having one or more templates encoded on them. This allows a user to store templates and provide them along with a voice sample. A device could record the audio, create a template and compare it against templates stored on the smart card.

### Usage Patterns

According to certain embodiments of the current disclosure, verification may be more robust by associating a usage pattern to a sound template. For example and without limitation, if a user regularly arrives at a certain location every day and enters a voice command to gain entrance, a record of the entrance times may be used as part of a verification scheme. This has the effect of providing a higher confidence that the proper speaker is present than a voice command entered at a time when one from that user would not be expected.

Similarly a voice verification system may provide access to users in response to a voice command at varying locations throughout the day. For example, and without limitation, to enter a building using voice commands and then gain further access to spaces within that building using different voice commands. If the user habitually enters a building at a certain time and then routinely enters a high security area within a certain time, then a historical record of probable entrance times can augment a determination that the user is the proper user.

One benefit to usage patterns is the ability to locate a user within a building complex. For example and without limitation, if a complex operates by allowing access to certain areas using the sound techniques disclosed herein, a user's location may be determined or historical usage data may be used to extrapolate a user's location.

In addition to successful building entrance attempts, failed attempts may also be analyzed to characterize system performance. For example, and without limitation, if a user normally must speak 3 times before the system provides an acceptable confidence indication, but for some reason now requires 5 or 6 attempts, then that could indicate that the template needs updating or the transducer is degraded.

Additional procedures such as “layering” may be employed in a speech verification system. Layering would use multiple samples of a person speech, or combinations of multiple speakers to provide verification. For example and without limitation, to identify if a speech input is from a live person or from a recording. If a recorded voice is used, the template formed will be identical (or nearly identical) every time. Since a human voice would be expected to have a certain amount of variation, a template identical to a previously created template may indicate an attempt at fraud. To implement this scheme, a usage pattern storing the template from a user each time the user uses his or her voice would provide an historical record. When verification is used, a search of the historical record of templates could be performed to look for substantially identical templates. If one is found, then other techniques are employed to verify a live person is speaking. These techniques may employ a speech recognition system or a question/response system similar to that disclosed in the method of FIG. 6.

Multiple speakers may be used to implement a verification system according to certain embodiments. In operation, two or more different speakers would be required to meet minimal correlations with stored voice templates. The techniques described herein may be employed to vary the requisite richness or method used to verify each speaker's voice. In addition, if a speaker's voice fails a verification procedure, another speaker may be used to complement the verification process. For example and without limitation, if a first speaker attempts a verification procedure and fails, a technique similar to the question/response method described above may be employed to have a second speaker provide a voice sample. This voice sample may be verified, in affect, speaking for the first speaker.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A method comprising:
receiving, at a server, first data, said first data including information representing an audio signal;
creating a template in response to a portion of the first data, and
storing the template in a memory.

2. The methods of claim 1 wherein the structured data is digitized speech.

3. The method of claim 1 wherein the first data includes at least one of a location, a user, a time, a device or a unique identifier.

4. The method of claim 1 wherein the template is an array representing spectral components of at least a portion of the audio signal.

5. The method of claim 4 wherein the spectral components comprise the substantially predominate frequencies of the audio signal.

6. The method of claim 1 wherein the template includes relationship information, said relationship information relating a first portion of the audio signal to a second portion of the audio signal.

7. The method of claim 1 further including:
processing the first data to eliminate noise.

8. The methods of claim 1 further including:
receiving second data, said second data including information associated with a second audio signal.

9. The method of claim 8 wherein the template is modified in response to the second audio signal

10. The method of claim 9 wherein said modification includes either adding a portion of the second data to the first data or subtracting a portion of the second data from the first data.

11. A method comprising
receiving a first template, said first template including an array of numbers characterizing at least a portion of an audio signal, said array further including identification information, and
storing said template in non-transitory storage media.

12. The method of claim 11 further including:
receiving a second template, said second template including an array of numbers characterizing at least a portion of an audio signal;
comparing the first template to the second template, and
transmitting a parameter responsive to said comparing.

13. The method of claim 12 wherein the parameter is a correlation indication.

14. The method of claim 12 further including:
receiving a minimum correlation value,
wherein the parameter indicates the comparing exceeded the minimal correlation value.

15. The method of claim 11 further including:
receiving a plurality of templates, each template of said plurality of templates including an array of numbers characterizing at least a portion of an said audio signal, and each template of said plurality of templates characterized by a different richness.

16. The method of claim 15 further including:
receiving a second template, said second template including an array of numbers characterizing at least a portion of an audio signal;
comparing at least one of the plurality of templates to the first template, and
transmitting a parameter responsive to said comparing.

17. The method of claim 16 wherein the parameter is a correlation indication.

18. The method of claim 16 further including:
receiving a minimum correlation value,
wherein the parameter indicates the comparing exceeded the minimal correlation value.

19. A method comprising:
receiving an audio signal from a sound transducer, and
creating a plurality of templates from said audio signal, each template characterized by a different richness.

20. The method of claim 19 further including:
receiving identification information associated with the audio signal and storing the template and identification information as non-transitory structured data.
